(19) United States
(12) Patent Application Publication
(10) Pub. No.: US 2025/0005106 A1
(43) Pub. Date: Jan. 2, 2025

(54) ROBUST GRAPH REPRESENTATION OF CAUSAL RELATIONSHIPS EXPRESSED IN A NATURAL LANGUAGE DOCUMENT

(71) Applicant: International Business Machines Corporation, Armonk, NY (US)

(72) Inventors: MD MARUF HOSSAIN, Tokyo (JP); Futoshi Iwama, Tokyo (JP); Mikio Takeuchi, Tokyo (JP)

(73) Assignee: International Business Machines Corporation, Armonk, NY (US)

(21) Appl. No.: 18/216,772

(22) Filed: Jun. 30, 2023

(51) Int. Cl. G06F 18/23213; G06F 40/289; G06N 3/0455

(52) U.S. Cl. CPC G06F 18/23213; G06F 40/289; G06N 3/0455

(57) ABSTRACT

An embodiment extracts, from a natural language document, using a first language model, a set of cause-effect pairs, each cause-effect pair comprising a pair of phrases, each phrase comprising a portion of the natural language document. An embodiment constructs a first graph representing the set of cause-effect pairs, each node in the first graph representing a phrase in the set of phrases, each edge in the first graph representing a cause-effect relationship between nodes connected by an edge. An embodiment measures a graph similarity between the first graph and a second graph constructed from phrases extracted from the natural language document. An embodiment incorporates, into a knowledge base responsive to determining that the graph similarity is above an acceptance threshold, the first graph.

### BACKGROUND

The present invention relates generally to natural language document analysis. More particularly, the present invention relates to a method, system, and computer program for a robust graph representation of causal relationships expressed in a natural language document.

A natural language document is a portion of text written in a human-readable language, such as English or French. A natural language document need not conform to any particular format, be in any particular human-readable language, or be in a grammatically correct form.

In natural language processing (NLP), a graph representation of a portion of text (e.g., a paragraph, sentence, phrase, or word) in a natural language document represents one or concepts expressed in the document in a structured form. Typically, a node of the graph represents a portion of text in the document, and an edge of the graph represents a relationship between two portions of text represented by nodes the edge connects. A graph representation of one or more natural language documents represents documents in a structured, standardized form and supports downstream tasks incorporating concepts expressed in the documents, such as text summarization, relation extraction, classification, clustering, sentiment analysis, and the addition of concepts expressed in a document to a knowledge base.

A causality relation, or a cause-effect relation, or a cause-effect relationship, in a natural language document is a relationship, expressed in the document, between one statement (a cause) and another statement (an effect of the first statement). The statements need not be complete sentences, need not be in the same sentence or in different sentences from each other, need not be grammatically correct, and can be expressed as questions and in other grammatical forms as well as statements. For example, in the sentence, “it's raining, so the ground is wet”, “it's raining” is a cause, and “the ground is wet” is an effect of that cause. In a graph representation of cause-effect relationships in one or more natural language documents (i.e., a causal graph), graph nodes representing text portions expressing the cause and effect, and an edge connecting two nodes represents the cause-effect relationship between the nodes.

Altering an input condition to the graph generation or altering a processing strategy used in generating the graph can change the generated graph, even when input documents remain the same. A robust graph, as the term is used herein, refers to a graph that has above a threshold amount of similarity (using a selected similarity metric) to another graph representing the same set of input documents, even though both graphs may have been generated under different input conditions or using different graph processing strategies. In contrast, a graph that is not robust changes an unacceptable amount under different input conditions or using different graph processing strategies.

### SUMMARY

The illustrative embodiments provide for a robust graph representation of causal relationships expressed in a natural language document. An embodiment includes extracting, from a natural language document, using a first language model, a set of cause-effect pairs, each cause-effect pair comprising a pair of phrases, each phrase comprising a portion of the natural language document. An embodiment includes constructing a first graph representing the set of cause-effect pairs, each node in the first graph representing a phrase in the set of phrases, each edge in the first graph representing a cause-effect relationship between nodes connected by an edge. An embodiment includes measuring a graph similarity between the first graph and a second graph constructed from phrases extracted from the natural language document. An embodiment includes incorporating, into a knowledge base responsive to determining that the graph similarity is above an acceptance threshold, the first graph. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for a robust graph representation of causal relationships expressed in a natural language document in accordance with an illustrative embodiment;

FIG. 4 depicts an example of a robust graph representation of causal relationships expressed in a natural language document in accordance with an illustrative embodiment;

FIG. 5 depicts a continued example of a robust graph representation of causal relationships expressed in a natural language document in accordance with an illustrative embodiment;

FIG. 6 depicts a continued example of a robust graph representation of causal relationships expressed in a natural language document in accordance with an illustrative embodiment;

FIG. 7 depicts a continued example of a robust graph representation of causal relationships expressed in a natural language document in accordance with an illustrative embodiment;

FIG. 8 depicts a continued example of a robust graph representation of causal relationships expressed in a natural language document in accordance with an illustrative embodiment;

FIG. 9 depicts an example of graph similarity calculations used in a robust graph representation of causal relationships expressed in a natural language document in accordance with an illustrative embodiment; and

FIG. 10 depicts a flowchart of an example process for a robust graph representation of causal relationships expressed in a natural language document in accordance with an illustrative embodiment.

### DETAILED DESCRIPTION

The illustrative embodiments recognize that it is desirable to use automated methods, rather than relying on human experts, to analyze natural language documents, extract data from the documents (e.g., facts or causal relationships expressed in a document), and use the extracted data to generate a graph representation of a document. Auto-generated causal graphs can be used to automate impact analysis at the time of an event (such as detected sentiment toward an event or topic in news articles or financial reports). For example, the faster data can be extracted from financial data such as a Form 10K in the United States (an annual report required by the U.S. Securities and Exchange Commission that includes a summary of a company's financial performance, in a combination of data tables and natural language text), the faster conclusions derived from the extracted data can be used to trade stocks and implement other financial strategies.

The illustrative embodiments also recognize that, using automated methods, altering an input condition to the graph generation or altering a processing strategy used in generating the graph can change the generated graph, even when the input document remains the same. However, because a graph representation of an input document is used in a variety of downstream tasks, such sensitivity to a change in an input condition or a processing strategy is means that a resulting graph representation cannot be trusted as a representation of an input document. An auto-generated causal graph representation that is robust for the same input data allows the user or downstream task to examine the base graph structure and understand the fundamental causal relations without being concerned with adjusting graph generation parameters. Thus, there is a need for a systematic and automated method of generating a robust graph representation.

The present disclosure addresses the deficiencies described above by providing a process (as well as a system, method, machine-readable medium, etc.) that, using a first language model, extracts a set of cause-effect pairs from a first natural language document, constructs a first graph representing the set of cause-effect pairs, measures a graph similarity between the first graph and a second graph constructed from phrases extracted from the natural language document, a robustness of the first graph by comparing the first graph with a second graph, and incorporates, into a knowledge base responsive to determining that the graph similarity is above an acceptance threshold, the first graph. Thus, the illustrative embodiments provide for a robust graph representation of causal relationships expressed in a natural language document.

An embodiment uses a language model to extract a set of cause-effect pairs from one or more natural language documents. Each cause-effect pair includes a pair of phrases in a cause-effect relationship, and each phrase includes a portion of a natural language document. In other words, one phrase expresses a cause and the other phrase expresses an effect of the cause. A phrase can express both an effect (of one cause) and a cause (of another effect). For example, in “it's raining, so the ground is wet, and I slipped”, “it's raining” is a cause, “the ground is wet” is an effect of that cause and a cause of the “I slipped” effect. A language model, or large language model (LLM), is a trained deep-learning model that understands and generates text in a human-like fashion, and can also be used in any downstream task such as classification, clustering, or sentiment analysis.

Some non-limiting examples of a presently available language model usable to extract cause-effect pairs from natural language text are Bidirectional Encoder Representations from Transformers (BERT), FinBERT (BERT trained with financial data,) RoBERTa (an extension of BERT with a changed pretraining procedure), and the Generative Pre-trained Transformer (GPT) family of models such as GPT-3, GPT-3.5, and GPT-4. A language model includes an embedding model. An embedding model generates an embedding, a numerical representation of a portion of text. The numerical representation captures the semantic meaning of what is being embedded. As a result, quantifying similarity between items represented by embeddings can be performed by a mathematical computation on the embeddings. One such mathematical computation is cosine similarity, the cosine of the angle between the different embeddings treated as vectors in a multidimensional vector space, is the dot product of the vectors divided by the product of their lengths. For example, a word embedding is a numerical representation of a word of text, and a cosine similarity between different word embeddings can be used to quantify how similar words represented by the embeddings are. As another example, a sentence embedding is a numerical representation of a phrase, sentence, or other grouping of words of text, and a cosine similarity between different sentence embeddings can be used to quantify how similar phrases represented by the embeddings are. Note that a word embedding is not limited to representing only one word, and a sentence embedding might represent only one word. Instead, a word embedding simply denotes representation of a typically smaller portion of text than a sentence embedding.

An embodiment constructs a first graph representing the set of cause-effect pairs. In the first graph, each node represents a phrase in the set of phrases, and each edge (connecting two nodes) represents a cause-effect relationship between the nodes connected by the edge. For example, to represent “it's raining, so the ground is wet”, “it's raining” might be represented by node 1, “the ground is wet” might be represented by node 2, and the cause-effect relationship between the two phrases might be represented by an edge connecting node 1 and node 2. Techniques for constructing a graph are presently available.

An embodiment combines nodes of the first graph representing phrases with a similarity score above a clustering threshold value. To determine which nodes to combine, an embodiment constructs a similarity matrix, in which each row denotes a phrase in the set of cause-effect pairs, and each column also denotes a phrase in the set of cause-effect pairs. To compute an entry in the similarity matrix, an embodiment uses a sentence embedding model (typically included in a large language model) to convert a phrase to a corresponding embedding, computes a cosine similarity between the two embeddings denoted by a row-column intersection, and enters the computed cosine similarity in the appropriate row-column intersection (or cell) of the similarity matrix. An embodiment binarizes the similarity matrix by setting a cell value to one if the value already in the cell is above a clustering threshold value and setting a cell value to zero if the value already in the cell is less than or equal to the clustering threshold value. Using the binarized similarity matrix as an adjacency matrix, an embodiment generates a new, undirected graph (a graph with edges that do not have a direction). In an adjacency matrix, cells of the matrix indicate whether pairs of vertices are adjacent (i.e., connected to each other by an edge, if there is a 1 in a corresponding cell of the matrix) or not (if there is a 0 in the cell) in the resulting graph. Nodes in the undirected graph that are connected to each other represent phrases that have a similarity to each other above the clustering threshold value, and an embodiment combines these nodes into a combined node. An embodiment replaces the original nodes with the combined node in the first graph, and labels the combined node with a phrase represented by a node that was combined into the combined node. Nodes in the undirected graph that are not connected to each other represent phrases that do not have a similarity to each other above the clustering threshold value, and an embodiment leaves these nodes unchanged in the first graph.

One embodiment sets a clustering threshold value to a value provided by a user or a pre-defined default value (e.g., 0.9, where similarity scores are in a 0-1 range). Another embodiment sets the clustering threshold value to a value that is larger than the similarity scores of 99% of the cause-effect phrase pairs calculated using the sentence embeddings provided by the language model that was used to create the first graph. Another embodiment uses a different value instead of 99%. A clustering threshold value represents a tradeoff between a too-high setting (only combining nodes representing phrases that are identical or very close to identical to each other) and a too-low setting (combining nodes representing phrases that are insufficiently similar to each other, resulting in the loss of some phrases, in the graph representation, that could include valuable information). A too-low setting can also result in self-loops (edges that connect a node to the same node), which are not useful in a causal graph.

An embodiment measures a graph similarity between the first graph and a second graph. Both the first and second graphs are constructed from the same cause-effect pair phrases extracted from one or more natural language documents in a manner described herein. However, the two graphs being compared differ in graph preparation strategy, such as at least one of the language model, embedding mode, and clustering threshold value. Prior to measuring the graph similarity, an embodiment has combined together nodes of the first graph representing phrases with a similarity score above a clustering threshold value, and combined together nodes of the second graph representing phrases with a similarity score above a clustering threshold value, although the clustering threshold values may have been different for each graph. In particular, an embodiment takes phrases represented by nodes in the larger graph as references, and matches each node in the smaller graph to the most similar reference node of the larger graph.

To measure node similarity, an embodiment computes a cosine similarity of sentence embeddings representing the phrases represented by each node, in a manner described herein. The larger graph of the two is the graph with more nodes. The node texts in the larger graph are taken as references, and each node in the smaller graph is first matched to the most similar reference node of the larger graph. This step is necessary to ensure that a phrase represented by a node in the smaller graph is not matched to multiple reference nodes of the larger graph. However, multiple nodes in the smaller graph can match with the same reference node of the larger graph. A node similarity threshold value is used to decide whether matched nodes in the larger graph and the smaller graph are sufficiently similar. For example, a node similarity threshold value of 1 enforces exact text matching, and a value lower than 1 allows paraphrase matching. One embodiment uses 0.96 as the node similarity threshold value. Other node similarity threshold values are also possible and contemplated within the illustrative embodiments. However, the node similarity threshold value should be greater than maximum similarity score among all the nodes in each graph being compared. If the node intersection set of the nodes in the two graphs includes all the nodes in the larger graph that have a match in the smaller graph, and the node union set of the nodes in the two graphs includes all the nodes in the larger graph as well as the unmatched nodes in the smaller graph, the node similarity is the number of nodes in the node intersection set divided by the number of nodes in the node union set. For example, if there are 5 nodes in the node intersection set and 6 nodes in the node union set, the node similarity is ⅚ or 0.83.

To measure edge similarity, an embodiment defines an edge set of each graph as the edges connecting the nodes in the intersection set of the nodes. Then, if the edge intersection set includes the edges that are common to each graph's edge set, and the edge union set includes the edges that are at least one graph's edge set, the edge similarity is the number of edges in the edge intersection set divided by the number of edges in the edge union set. For example, if there are 3 edges in the edge intersection set and 4 edges in the edge union set, the edge similarity is ¾ or 0.75.

An embodiment computes graph similarity by computing the geometric mean of the node and edge similarities, in other words by multiplying the node and edge similarities together and computing the square root of the result. Other methods of computing node, edge, and graph similarity are also possible and contemplated within the illustrative embodiments. If the graph similarity is above an acceptance threshold, an embodiment accepts the larger of the two graphs being compared (e.g., the first graph) as the final graph.

An embodiment computes additional metrics on the final graph. One embodiment computes a graph connectedness, as the number of nodes in the largest connected subgraph of the final graph divided by the total number of nodes in the final graph. For example, if there are 9 nodes in the largest connected subgraph of the final graph and 20 nodes total in the final graph, the graph's connectedness is 9/20, or 0.45, or 45%. Another embodiment computes an edge density of the final graph, as the number of edges in the graph divided by the number of possible edges in the graph. Other metrics on the final graph are also possible and contemplated within the scope of the illustrative embodiments. Although a final graph with a relatively high graph connectedness is desirable, as such a graph includes numerically more as well as more complex causal relationships, increasing the graph connectedness can also produce graphs that are not sufficiently similar when there are changes in the graph preparation method. Thus, an embodiment uses the threshold values described herein to increase graph connectedness as much as possible while still producing graphs that have a sufficiently high graph similarity to each other (e.g., around 0.9).

An embodiment incorporates the final graph into a knowledge base. Another embodiment uses the final graph to perform one or more downstream tasks, such as text summarization, relation extraction, classification, clustering, sentiment analysis.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

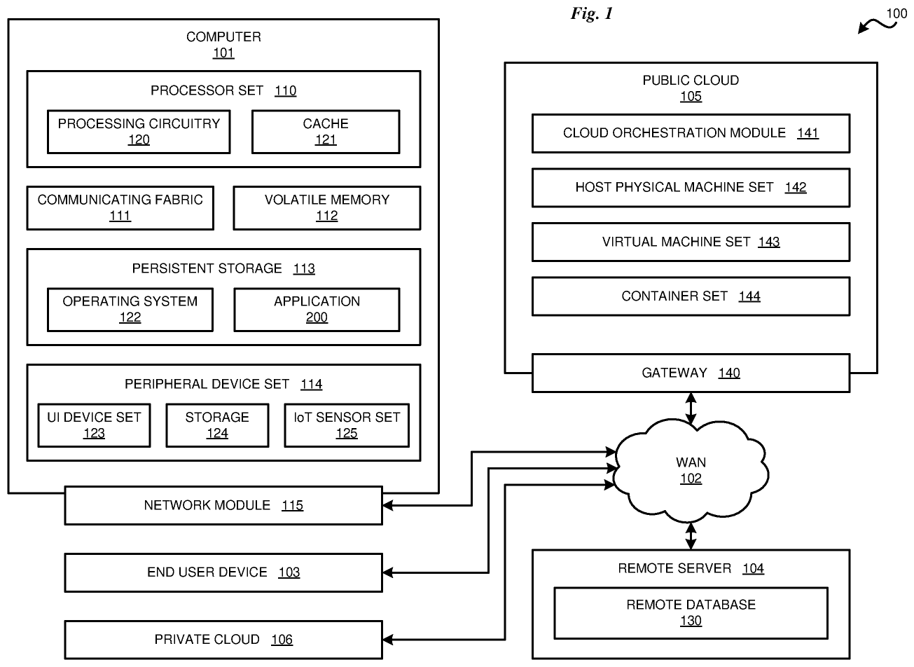

With reference to FIG. 1, this figure depicts a block diagram of a computing environment 100. Computing environment 100 contains an example of an environment for the execution of at least some of the computer code involved in performing the inventive methods, such as a robust graph representation of causal relationships expressed in a natural language document. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

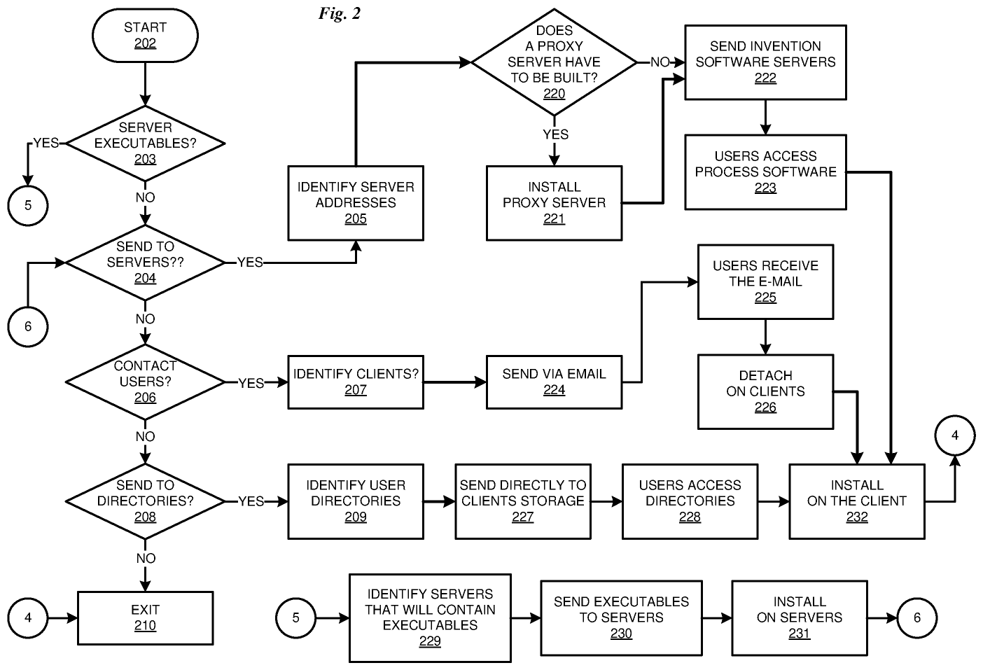

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software for a robust graph representation of causal relationships expressed in a natural language document may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

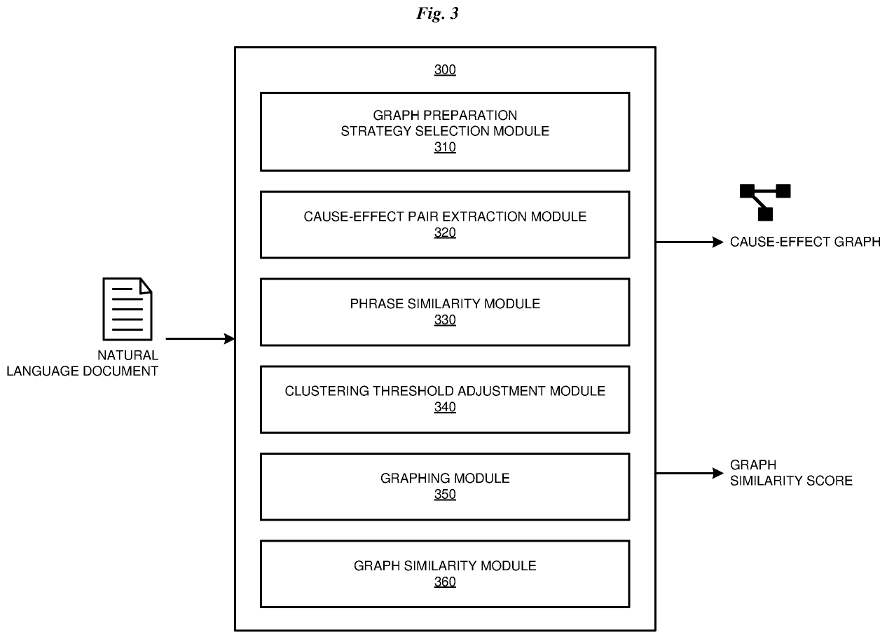

With reference to FIG. 3, this figure depicts a block diagram of an example configuration for a robust graph representation of causal relationships expressed in a natural language document in accordance with an illustrative embodiment. Application 300 is the same as application 200 in FIG. 1.

In the illustrated embodiment, graph preparation strategy selection module 310 selects a language model usable to extract cause-effect pairs from natural language text. A language model, or large language model (LLM), is a trained deep-learning model that understands and generates text in a human-like fashion, and can also be used in any downstream task such as classification, clustering, or sentiment analysis. Some non-limiting examples of a presently available language model usable to extract cause-effect pairs from natural language text are Bidirectional Encoder Representations from Transformers (BERT), FinBERT (BERT trained with financial data,) RoBERTa (an extension of BERT with a changed pretraining procedure), and the Generative Pre-trained Transformer (GPT) family of models such as GPT-3, GPT-3.5, and GPT-4.

Graph preparation strategy selection module 310 also selects an embedding model. An embedding model generates an embedding, a numerical representation of a portion of text. The numerical representation captures the semantic meaning of what is being embedded. As a result, quantifying similarity between items represented by embeddings can be performed by a mathematical computation on the embeddings. One such mathematical computation is cosine similarity, the cosine of the angle between the different embeddings treated as vectors in a multidimensional vector space, is the dot product of the vectors divided by the product of their lengths. For example, a word embedding is a numerical representation of a word of text, and a cosine similarity between different word embeddings can be used to quantify how similar words represented by the embeddings are. As another example, a sentence embedding is a numerical representation of a phrase, sentence, or other grouping of words of text, and a cosine similarity between different sentence embeddings can be used to quantify how similar phrases represented by the embeddings are. Note that a word embedding is not limited to representing only one word, and a sentence embedding might represent only one word. Instead, a word embedding simply denotes representation of a typically smaller portion of text than a sentence embedding. Graph preparation strategy selection module 310 also selects one or more threshold values used in generating a causal graph as described herein.

Cause-effect pair extraction module 320 uses a language model to extract a set of cause-effect pairs from one or more natural language documents. Each cause-effect pair includes a pair of phrases in a cause-effect relationship, and each phrase includes a portion of a document. In other words, one phrase expresses a cause and the other phrase expresses an effect of the cause. A phrase can express both an effect (of one cause) and a cause (of another effect). For example, in “it's raining, so the ground is wet, and I slipped”, “it's raining” is a cause, “the ground is wet” is an effect of that cause and a cause of the “I slipped” effect.

Graphing module 350 constructs a first graph representing the set of cause-effect pairs. In the first graph, each node represents a phrase in the set of phrases, and each edge (connecting two nodes) represents a cause-effect relationship between the nodes connected by the edge. For example, to represent “it's raining, so the ground is wet”, “it's raining” might be represented by node 1, “the ground is wet” might be represented by node 2, and the cause-effect relationship between the two phrases might be represented by an edge connecting node 1 and node 2. Techniques for constructing a graph are presently available.

Phrase similarity module 330 combines nodes of the first graph representing phrases with a similarity score above a clustering threshold value. To determine which nodes to combine, module 330 constructs a similarity matrix, in which each row denotes a phrase in the set of cause-effect pairs, and each column also denotes a phrase in the set of cause-effect pairs. To compute an entry in the similarity matrix, module 330 uses a sentence embedding model (typically included in a large language model) to convert a phrase to a corresponding embedding, computes a cosine similarity between the two embeddings denoted by a row-column intersection, and enters the computed cosine similarity in the appropriate row-column intersection (or cell) of the similarity matrix. Module 330 binarizes the similarity matrix by setting a cell value to one if the value already in the cell is above a clustering threshold value and setting a cell value to zero if the value already in the cell is less than or equal to the clustering threshold value. Using the binarized similarity matrix as an adjacency matrix, module 330 generates a new, undirected graph (a graph with edges that do not have a direction). In an adjacency matrix, cells of the matrix indicate whether pairs of vertices are adjacent (i.e., connected to each other by an edge, if there is a 1 in a corresponding cell of the matrix) or not (if there is a 0 in the cell) in the resulting graph. Nodes in the undirected graph that are connected to each other represent phrases that have a similarity to each other above the clustering threshold value, and module 330 combines these nodes into a combined node. Graphing module 350 replaces the original nodes with the combined node in the first graph, and labels the combined node with a phrase represented by a node that was combined into the combined node. Nodes in the undirected graph that are not connected to each other represent phrases that do not have a similarity to each other above the clustering threshold value, and module 350 leaves these nodes unchanged in the first graph.

Clustering threshold adjustment module 340 sets a clustering threshold value used by module 330. One implementation of module 340 sets a clustering threshold value to a value provided by a user or a pre-defined default value (e.g., 0.9, where similarity scores are in a 0-1 range). Another implementation of module 340 sets a clustering threshold value to a value that is larger than the similarity scores of 99% of the cause-effect phrase pairs calculated using the sentence embeddings provided by the language model that was used to create the first graph. Another embodiment uses a different value instead of 99%. A clustering threshold value represents a tradeoff between a too-high setting (only combining nodes representing phrases that are identical or very close to identical to each other) and a too-low setting (combining nodes representing phrases that are insufficiently similar to each other, resulting in the loss of some phrases, in the graph representation, that could include valuable information). A too-low setting can also result in self-loops (edges that connect a node to the same node), which are not useful in a causal graph.

Graph similarity module 360 measures a graph similarity between the first graph and a second graph. Both the first and second graphs are constructed from the same cause-effect pair phrases. However, the two graphs being compared differ in graph preparation strategy, such as at least one of the language model, embedding mode, and clustering threshold value. Prior to measuring the graph similarity, modules 330 and 350 have combined together nodes of the first graph representing phrases with a similarity score above a clustering threshold value, and combined together nodes of the second graph representing phrases with a similarity score above a clustering threshold value, although the clustering threshold values may have been different for each graph. In particular, module 360 takes phrases represented by nodes in the larger graph as references, and matches each node in the smaller graph to the most similar reference node of the larger graph.

To measure node similarity, module 360 computes a cosine similarity of sentence embeddings representing the phrases represented by each node, in a manner described herein. The larger graph of the two is the graph with more nodes. The node texts in the larger graph are taken as references, and each node in the smaller graph is first matched to the most similar reference node of the larger graph. This step is necessary to ensure that a phrase represented by a node in the smaller graph is not matched to multiple reference nodes of the larger graph. However, multiple nodes in the smaller graph can match with the same reference node of the larger graph. A node similarity threshold value is used to decide whether matched nodes in the larger graph and the smaller graph are sufficiently similar. For example, a node similarity threshold value of 1 enforces exact text matching, and a value lower than 1 allows paraphrase matching. One implementation of module 360 uses 0.96 as the node similarity threshold value. Other node similarity threshold values are also possible. However, the node similarity threshold value should be greater than maximum similarity score among all the nodes in each graph being compared. If the node intersection set of the nodes in the two graphs includes all the nodes in the larger graph that have a match in the smaller graph, and the node union set of the nodes in the two graphs includes all the nodes in the larger graph as well as the unmatched nodes in the smaller graph, the node similarity is the number of nodes in the node intersection set divided by the number of nodes in the node union set. For example, if there are 5 nodes in the node intersection set and 6 nodes in the node union set, the node similarity is ⅚ or 0.83.

To measure edge similarity, module 360 defines an edge set of each graph as the edges connecting the nodes in the intersection set of the nodes. Then, if the edge intersection set includes the edges that are common to each graph's edge set, and the edge union set includes the edges that are at least one graph's edge set, the edge similarity is the number of edges in the edge intersection set divided by the number of edges in the edge union set. For example, if there are 3 edges in the edge intersection set and 4 edges in the edge union set, the edge similarity is ¾ or 0.75.

Module 360 computes graph similarity by computing the geometric mean of the node and edge similarities, in other words by multiplying the node and edge similarities together and computing the square root of the result. Other methods of computing node, edge, and graph similarity are also possible. If the graph similarity is above an acceptance threshold, module 360 accepts the larger of the two graphs being compared (e.g., the first graph) as the final graph.

Module 360 computes additional metrics on the final graph. One implementation of module 360 computes a graph connectedness, as the number of nodes in the largest connected subgraph of the final graph divided by the total number of nodes in the final graph. For example, if there are 9 nodes in the largest connected subgraph of the final graph and 20 nodes total in the final graph, the graph's connectedness is 9/20, or 0.45, or 45%. Another implementation of module 360 computes an edge density of the final graph. Other metrics on the final graph are also possible. Although a final graph with a relatively high graph connectedness is desirable, as such a graph includes numerically more as well as more complex causal relationships, increasing the graph connectedness can also produce graphs that are not sufficiently similar when there are changes in the graph preparation method. Thus, application 300 uses the threshold values described herein to increase graph connectedness as much as possible while still producing graphs that have a sufficiently high graph similarity to each other (e.g., around 0.9).

Application 300 incorporates the final graph into a knowledge base. Another implementation of application 300 uses the final graph to perform one or more downstream tasks, such as text summarization, relation extraction, classification, clustering, sentiment analysis.

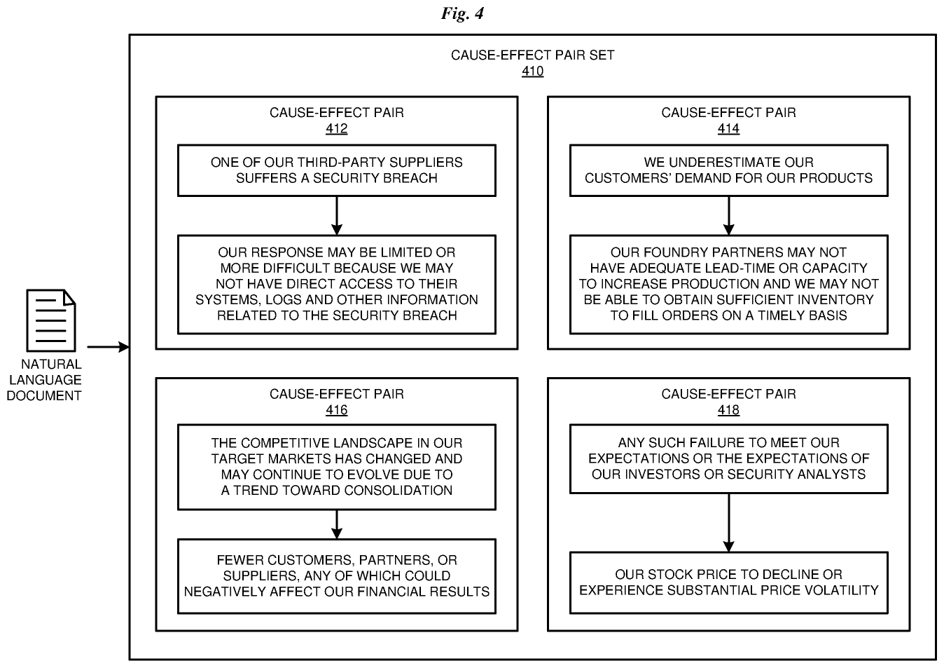

With reference to FIG. 4, this figure depicts an example of a robust graph representation of causal relationships expressed in a natural language document in accordance with an illustrative embodiment. The example can be executed using application 300 in FIG. 3.

In particular, FIG. 4 depicts cause-effect pair set 410, including cause-effect pairs 412, 414, 416, and 418, each extracted from one or more natural language documents. Note that the examples depicted do not refer to any particular company or any particular financial situation or outlook, and are only intended as illustrative examples.

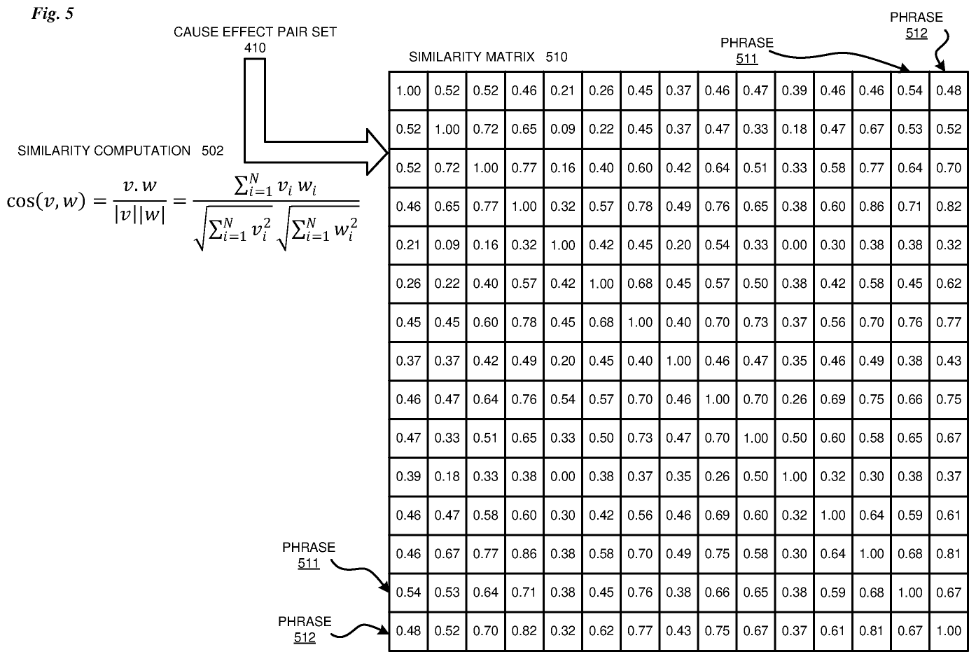

With reference to FIG. 5, this figure depicts a continued example of a robust graph representation of causal relationships expressed in a natural language document in accordance with an illustrative embodiment. Cause-effect pair set 410 is the same as cause-effect pair set 410 in FIG. 4.

As depicted, application 300 has used cause-effect pair set 410 to construct similarity matrix 510, in which each row denotes a phrase in the set of cause-effect pairs (e.g., phrases 511 and 512), and each column also denotes a phrase in the set of cause-effect pairs (e.g., phrases 511 and 512). To compute an entry in similarity matrix 510, application 300 uses a sentence embedding model (typically included in a large language model) to convert a phrase to a corresponding embedding, uses similarity computation 502 to compute a cosine similarity between the two embeddings denoted by a row-column intersection, and enters the computed cosine similarity in the appropriate row-column intersection (or cell) of similarity matrix 510.

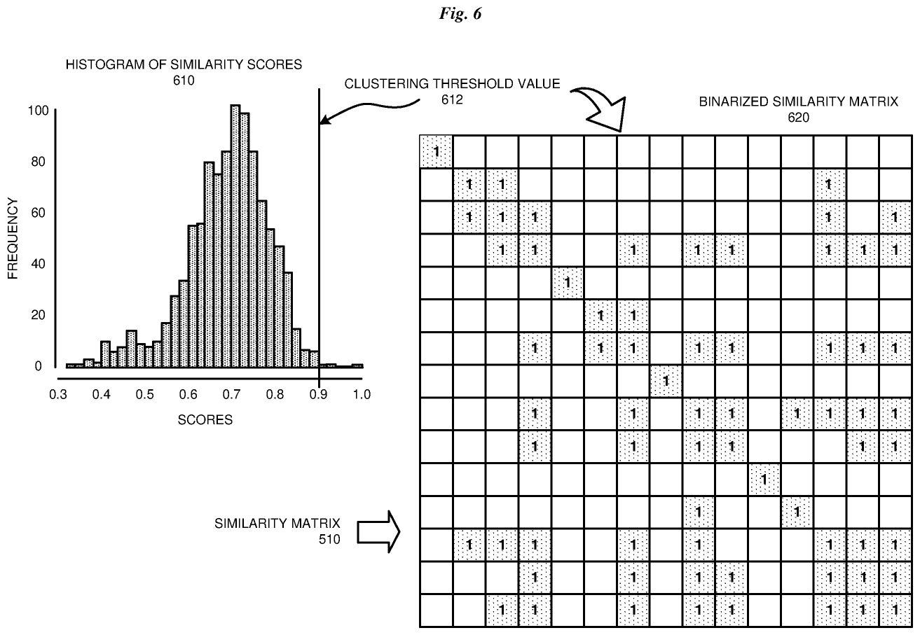

With reference to FIG. 6, this figure depicts a continued example of a robust graph representation of causal relationships expressed in a natural language document in accordance with an illustrative embodiment. Similarity matrix 510 is the same as similarity matrix 510 in FIG. 5.

As depicted, application 300 binarizes similarity matrix 510 (generating binarized similarity matrix 620) by setting a cell value to one if the value already in the cell is above clustering threshold value 612 and setting a cell value to zero if the value already in the cell is less than or equal to clustering threshold value 612. Clustering threshold value 612 is set to a value that is larger than the similarity scores of 99% of the cause-effect phrase pairs calculated using the sentence embeddings provided by the language model that was used to create the first graph, as illustrated by histogram of similarity scores 610 of the cause-effect phrase pairs.

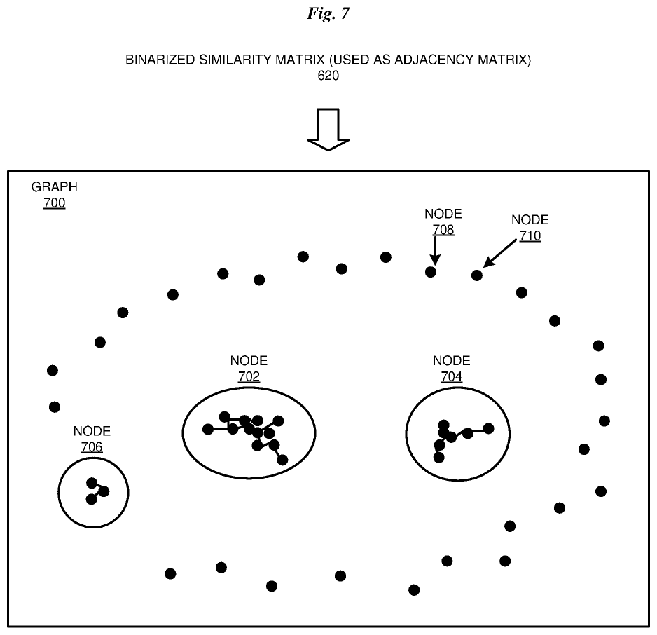

With reference to FIG. 7, this figure depicts a continued example of a robust graph representation of causal relationships expressed in a natural language document in accordance with an illustrative embodiment. Binarized similarity matrix 620 is the same as binarized similarity matrix 620 in FIG. 6.

As depicted, using binarized similarity matrix 620 as an adjacency matrix, application 300 generates a new, undirected graph 700 (a graph with edges that do not have a direction). In an adjacency matrix, cells of the matrix indicate whether pairs of vertices are adjacent (i.e., connected to each other by an edge, if there is a 1 in a corresponding cell of the matrix) or not (if there is a 0 in the cell) in the resulting graph. Nodes in graph 700 that are connected to each other represent phrases that have a similarity to each other above the clustering threshold value, and thus application 300 combines these nodes into combined nodes 702, 704, and 706. Nodes in the undirected graph that are not connected to each other (e.g., nodes 708 and 710) represent phrases that do not have a similarity to each other above the clustering threshold value, and application 300 leaves these nodes unchanged in the first graph.

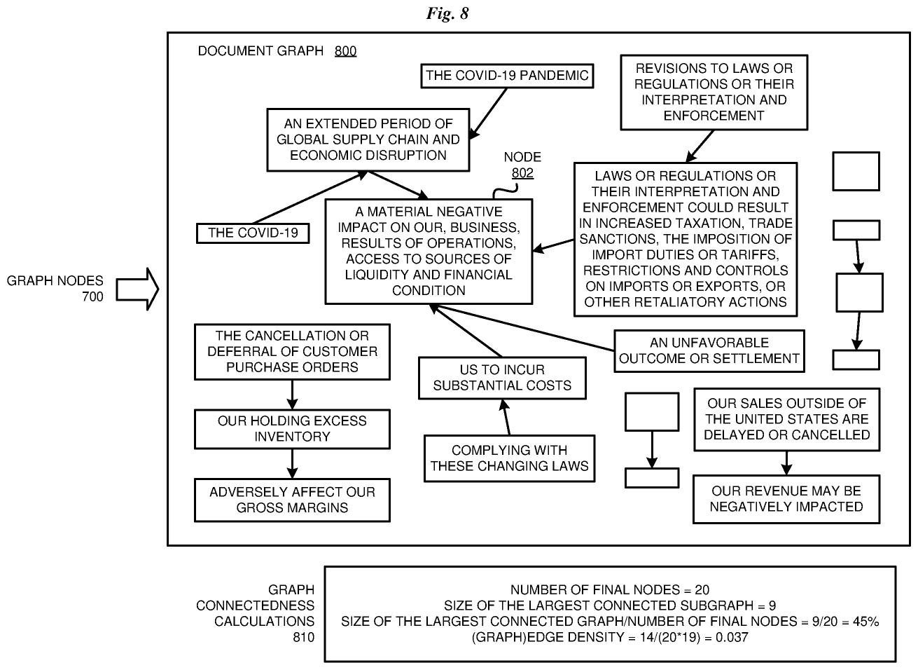

With reference to FIG. 8, this figure depicts a continued example of a robust graph representation of causal relationships expressed in a natural language document in accordance with an illustrative embodiment. Graph 700 is the same as graph 700 in FIG. 7.

Document graph 800 depicts a causal graph derived from cause-effect pair set 410, using the combined nodes in graph 700. Document graph 800 includes, for example, node 802. Graph connectedness calculations 810 depicts a calculation of graph connectedness of graph 800, as the number of nodes in the largest connected subgraph of graph 800 divided by the total number of nodes in graph 800. For example, if there are 9 nodes in the largest connected subgraph of the final graph and 20 nodes total in the final graph, the graph's connectedness is 9/20, or 0.45, or 45%. Graph connectedness calculations 810 also depicts computation of an edge density of the final graph, as the number of edges in the graph (here, 14) divided by the number of possible edges in the graph (here, 20*19).

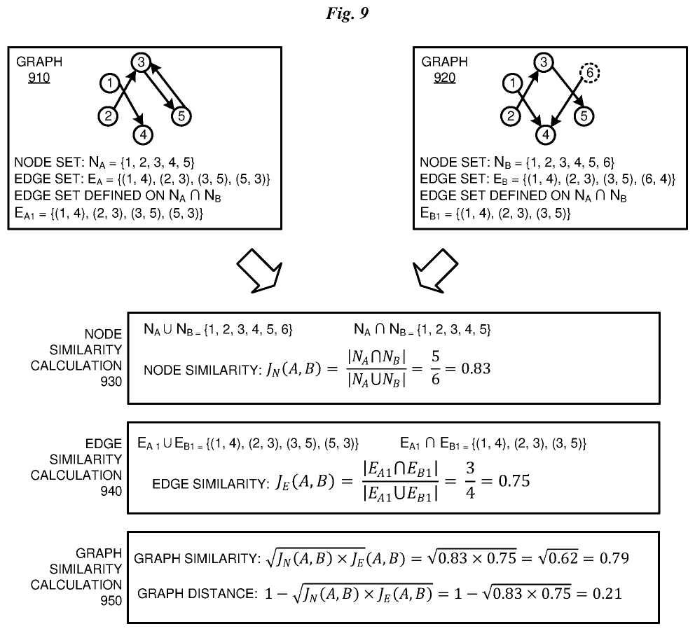

With reference to FIG. 9, this figure depicts an example of graph similarity calculations used in a robust graph representation of causal relationships expressed in a natural language document in accordance with an illustrative embodiment. The example can be executed using application 300 in FIG. 3.

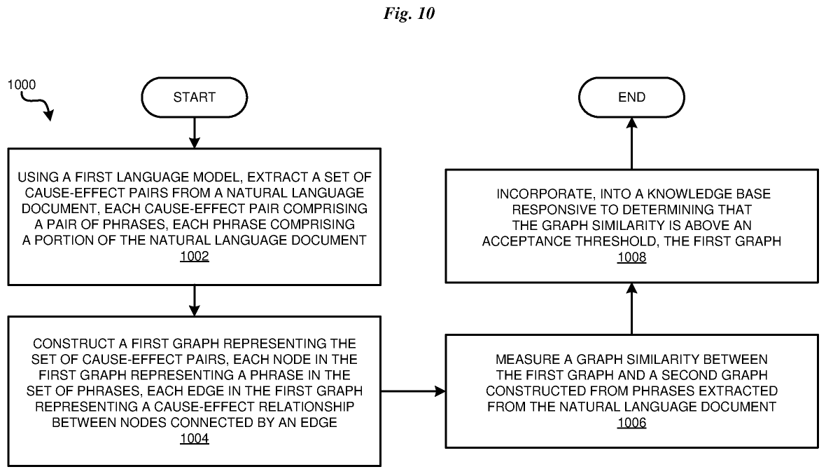

In particular, FIG. 10 depicts graph similarity calculations comparing graphs 910 and 920. To measure node similarity, application 300 computes a cosine similarity of sentence embeddings representing the phrases represented by each node, in a manner described herein. As depicted in node similarity calculation 930, the node intersection set of the nodes in the two graphs includes all the nodes in the larger graph that have a match in the smaller graph (N_{A}∩N_{B}, or nodes 1, 2, 3, 4, and 5). The node union set of the nodes in the two graphs includes all the nodes in the larger graph as well as the unmatched nodes in the smaller graph (the union of N_{A} and N_{B}, or nodes 1, 2, 3, 4, 5, and 6). The node similarity is the number of nodes in the node intersection set divided by the number of nodes in the node union set. Since there are 5 nodes in the node intersection set and 6 nodes in the node union set, the node similarity is ⅚ or 0.83.

To measure edge similarity, application 300 defines an edge set of each graph as the edges connecting the nodes in the intersection set of the nodes (here, E_{A1} and E_{B1}). As depicted in edge similarity calculation 940, the edge intersection set includes the edges that are common to each graph's edge set, and the edge union set includes the edges that are at least one graph's edge set, and the edge similarity is the number of edges in the edge intersection set divided by the number of edges in the edge union set. For example, if there are 3 edges in the edge intersection set and 4 edges in the edge union set, the edge similarity is ¾ or 0.75.

Application 300 computes graph similarity as depicted in graph similarity calculation 950, by computing the geometric mean of the node and edge similarities, in other words by multiplying the node and edge similarities together and computing the square root of the result. Graph similarity calculation 950 also includes a graph distance calculation, by subtracting the graph similarity from 1.

With reference to FIG. 10, this figure depicts a flowchart of an example process for a robust graph representation of causal relationships expressed in a natural language document in accordance with an illustrative embodiment. Process 1000 can be implemented in application 300 in FIG. 3.

In the illustrated embodiment, at block 1002, the process uses a first language model, extract a set of cause-effect pairs from a natural language document, each cause-effect pair comprising a pair of phrases, each phrase comprising a portion of the natural language document. At block 1004, the process constructs a first graph representing the set of cause-effect pairs, each node in the first graph representing a phrase in the set of phrases, each edge in the first graph representing a cause-effect relationship between nodes connected by an edge. At block 1006, the process measures a graph similarity between the first graph and a second graph constructed from phrases extracted from the natural language document. At block 1008, the process incorporates, into a knowledge base responsive to determining that the graph similarity is above an acceptance threshold, the first graph. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
extracting, from a natural language document, using a first language model, a set of cause-effect pairs, each cause-effect pair comprising a pair of phrases, each phrase comprising a portion of the natural language document;
constructing a first graph representing the set of cause-effect pairs, each node in the first graph representing a phrase in the set of phrases, each edge in the first graph representing a cause-effect relationship between nodes connected by an edge;
measuring a graph similarity between the first graph and a second graph constructed from phrases extracted from the natural language document; and
incorporating, into a knowledge base responsive to determining that the graph similarity is above an acceptance threshold, the first graph.

2. The computer-implemented method of claim 1, wherein the first graph comprises a combined node, the combined node representing two phrases in the set of phrases with a similarity score above a first clustering threshold value.

3. The computer-implemented method of claim 2, wherein the first clustering threshold value is set according to similarity scores of phrases in the set of phrases.

4. The computer-implemented method of claim 2, wherein the similarity score is computed by computing a cosine similarity between sentence embeddings, each sentence embedding comprising a numerical representation of a phrase in the set of phrases, each sentence embedding computed using a first embedding model.

5. The computer-implemented method of claim 4, wherein the second graph is constructed using a different embedding model from the first embedding model.

6. The computer-implemented method of claim 2, wherein the second graph is constructed using a different clustering threshold value from the first clustering threshold value.

7. The computer-implemented method of claim 1, wherein the graph similarity comprises a combination of a node similarity measurement and an edge similarity measurement between the first graph and the second graph.

8. A computer program product comprising one or more computer readable storage media, and program instructions collectively stored on the one or more computer readable storage media, the program instructions executable by a processor to cause the processor to perform operations comprising:
extracting, from a natural language document, using a first language model, a set of cause-effect pairs, each cause-effect pair comprising a pair of phrases, each phrase comprising a portion of the natural language document;
constructing a first graph representing the set of cause-effect pairs, each node in the first graph representing a phrase in the set of phrases, each edge in the first graph representing a cause-effect relationship between nodes connected by an edge;
measuring a graph similarity between the first graph and a second graph constructed from phrases extracted from the natural language document; and
incorporating, into a knowledge base responsive to determining that the graph similarity is above an acceptance threshold, the first graph.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the first graph comprises a combined node, the combined node representing two phrases in the set of phrases with a similarity score above a first clustering threshold value.

12. The computer program product of claim 11, wherein the first clustering threshold value is set according to similarity scores of phrases in the set of phrases.

13. The computer program product of claim 11, wherein the similarity score is computed by computing a cosine similarity between sentence embeddings, each sentence embedding comprising a numerical representation of a phrase in the set of phrases, each sentence embedding computed using a first embedding model.

14. The computer program product of claim 13, wherein the second graph is constructed using a different embedding model from the first embedding model.

15. The computer program product of claim 11, wherein the second graph is constructed using a different clustering threshold value from the first clustering threshold value.

16. The computer program product of claim 8, wherein the graph similarity comprises a combination of a node similarity measurement and an edge similarity measurement between the first graph and the second graph.

17. A computer system comprising a processor and one or more computer readable storage media, and program instructions collectively stored on the one or more computer readable storage media, the program instructions executable by the processor to cause the processor to perform operations comprising:
extracting, from a natural language document, using a first language model, a set of cause-effect pairs, each cause-effect pair comprising a pair of phrases, each phrase comprising a portion of the natural language document;
constructing a first graph representing the set of cause-effect pairs, each node in the first graph representing a phrase in the set of phrases, each edge in the first graph representing a cause-effect relationship between nodes connected by an edge;
measuring a graph similarity between the first graph and a second graph constructed from phrases extracted from the natural language document; and
incorporating, into a knowledge base responsive to determining that the graph similarity is above an acceptance threshold, the first graph.

18. The computer system of claim 17, wherein the first graph comprises a combined node, the combined node representing two phrases in the set of phrases with a similarity score above a first clustering threshold value.

19. The computer system of claim 18, wherein the first clustering threshold value is set according to similarity scores of phrases in the set of phrases.

20. The computer system of claim 18, wherein the similarity score is computed by computing a cosine similarity between sentence embeddings, each sentence embedding comprising a numerical representation of a phrase in the set of phrases, each sentence embedding computed using a first embedding model.
